(19) United States
(12) Patent Application Publication
(10) Pub. No.: US 2015/0230070 A1
(43) Pub. Date: Aug. 13, 2015

(54) System and Methods for Increasing a Maximum Number of Simultaneous Calls on a Service Subscription of a Multi-SIM Device

(71) Applicant: QUALCOMM Incorporated, San Diego, CA (US)

(72) Inventors: Pavan Kumar Kadiyala, Hyderabad (IN); Ravi Kanth Kotreka, Hyderabad (IN)

(73) Assignee: QUALCOMM Incorporated, San Diego, CA (US)

(21) Appl. No.: 14/179,594

(22) Filed: Feb. 13, 2014

(51) Int. Cl. H04W 4/16; H04W 72/02; H04W 88/06

(52) U.S. Cl. CPC H04W 4/16; H04W 88/06; H04W 72/02

(57) ABSTRACT

Methods and devices are disclosed for increasing capacity for handling simultaneous calls to a particular SIM of a wireless communication device having at least a first and second SIM and corresponding first and second radio resources. If a preset maximum number of calls has been reached for a first of the modem stacks, and a radio resource of another other modem stack is handling less than its preset maximum number of calls, the wireless device may send a signal to the network serving the first SIM to activate the call forwarding function. While activated, calls addressed to the first SIM may be received by the wireless device on radio resource associated with the other SIM.

### BACKGROUND

Multi-SIM wireless devices are cellular telephone devices that include more than one subscriber identification module (SIM). Multi-SIM wireless devices have become increasing popular because of the versatility that they provide, particularly in countries where there are many service providers. For example, dual-SIM wireless devices may allow a user to implement two different cellular service subscriptions or plans with different service providers, with separate numbers and bills, on the same device (e.g., business account and personal account). Also, during travel, users can obtain local SIM cards and pay local call rates in the destination country. By using multiple SIMs, a user may take advantage of different service pricing plans and save on mobile data usage.

In various types of multi-SIM wireless communication devices, each modem stack associated with a subscription may store information provisioned by its respective network operator in a SIM, which may allow the SIM to support use of various different communication services. For example, various wireless networks may be configured to handle different types of data, use different communication modes, implement different radio access technologies, etc.

One type of multi-SIM wireless device, referred to as a dual-SIM dual active (DSDA) device, allows simultaneous active connections with the networks corresponding to two SIMs using separate radio frequency (RF) transmit/receive chains associated with each SIM. Another type of multi-SIM wireless device, referred to as a dual-SIM dual standby (DSDS) device, includes a single radio resource and typically provides for a “standby” mode (i.e., idle mode) in which services associated with either SIM may originate or terminate a communication (e.g., a voice call or data call), and in which services associated with both SIMs may receive pages using the shared radio resource.

Typically, the RF chain associated with each SIM of a multi-SIM device, when in active/dedicated mode, may be capable of handling up to two simultaneous communications using various supplementary services provided cellular networks. For example, using a call waiting service available on most cellular telephone networks, an RF chain associated with a SIM of a DSDA device can be engaged in a first active call while keeping a second call in a suspended state (i.e., on hold). In another example, using a call holding service, a user may toggle the two ongoing calls on the service (e.g., the telephone number) associated with the SIM between active and held states. However, if there is another incoming call to the service associated with that SIM, either the incoming call will not be offered to the wireless device, or the first or second existing call will be dropped to allow the user to receive the incoming call notification.

Further, since SIMs of a multi-SIM device are configured independent of one another, with separate numbers and network interactions. Therefore, regardless of what is occurring with services associated with other SIMs, each SIM of a DSDA device may maintain idle mode on its associated baseband-RF resource chain until a paging request to that SIM is received and/or a mobile originating call using the SIM is started.

### SUMMARY

Systems, methods, and devices of the various embodiments enable increasing capacity for handling simultaneous calls on a DSDA multi-SIM wireless communication device having at least a first SIM associated with a first radio resource and a second SIM associated with a second radio resource by notifying a network service associated to with the first SIM to forward calls to the phone number associated with the second SIM when a maximum number of simultaneous calls are active or on hold on the service associated with the first SIM. In an embodiment this may be accomplished by monitoring a count of total ongoing calls being handled on each of a first modem stack and a second modem stack, in which the first and second modem stacks are respectively associated with the first and second SIMs, determining whether the count of total ongoing calls being handled on the first modem stack is equal to a first preset maximum count value, and in response determining that the count of total ongoing calls being handled on the first modem stack is equal to the preset maximum count value, determining whether the count of total ongoing calls being handled on the second modem stack is less than a second preset maximum count value (as would be the case if the second radio resource is idle), and sending a signal to the first network activating a call forwarding function in response to determining that the count of total ongoing calls being handled on the second modem stack is less than the second preset maximum count value, in which, based on the activated call forwarding function, additional incoming calls addressed to the first SIM may be received on the wireless device using the second radio resource.

In some embodiments the count of total ongoing calls being handled by the first modem stack is a sum of active and held calls on the first modem stack, and the preset maximum count value is established by the first network. In some embodiments the preset maximum count value established by the first network is two calls, in which the first modem stack is capable of handling two ongoing calls by invoking supplementary call waiting and call holding services provided by the first network.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a communication system block diagram of a network suitable for use with the various embodiments.

FIG. 2 is a component block diagram illustrating a dual-SIM wireless communications device according to an embodiment.

FIG. 3 is a system architecture diagram illustrating example protocol layers of modem stacks implemented by the dual-SIM wireless communication device of FIG. 2.

FIG. 4 is a process flow diagram illustrating an embodiment method of implementing a dynamic call forwarding mechanism to handle additional incoming calls to a SIM of a dual-SIM wireless communication device.

FIG. 5 is a message flow diagram between example modem stacks and network components for implementing an embodiment dynamic call forwarding mechanism on a dual-SIM wireless communication device.

FIG. 6 is a component diagram of an example wireless device suitable for use with the various embodiments.

FIG. 7 is a component diagram of another example wireless device suitable for use with the various embodiments.

### DETAILED DESCRIPTION

The various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the invention or the claims.

The various embodiments increase the capacity of a multi-SIM multi-access wireless device (e.g., a DSDA wireless device) for handling multiple incoming calls addressed to a particular SIM (or telephone number associated with the SIM) that is already participating in a maximum number of calls supported by a network service. In the various embodiments, when the modem stack associated with a first SIM is handling its maximum call capacity, the wireless device may identify another SIM currently in an idle mode, and may utilize the modem stack and radio resource of this idle SIM to receive calls addressed to the first SIM by invoking a call forwarding functionality of the service associated with the first SIM to forward calls to the phone number associated with the idle SIM. When the first SIM modem stack is no longer handling its maximum capacity (i.e., when one of the calls on the first SIM ends), the wireless device may cancel the call forwarding functionality. The dynamic nature of this call forwarding mechanism provides efficiency by allowing the wireless device to temporarily “repurpose” an idle RF resource/SIM for the time necessary based on current call conditions.

The terms “wireless device,” and “wireless communications device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways enabled by two or more SIMs.

As used herein, the terms “SIM”, “SIM card” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM. For example, references to assigning a radio resource to a SIM (or granting a SIM radio access) means that the radio resource has been allocated to establishing or using a communication service with a particular network that is enabled by the information stored in that SIM.

As used herein, the terms “multi-SIM wireless communication device,” “multi-SIM wireless device” “dual-SIM wireless communication device” “dual-SIM dual active device” and “DSDA device” are used interchangeably to describe a wireless device that is configured with more than one SIM and is capable of independently handling communications with networks of two or more subscriptions.

As used herein, the terms “wireless network,” “cellular network,” “system” “public land mobile network” and “PLMN” are used interchangeably to refer to a wireless network of a carrier associated with a wireless device and/or subscription on a wireless device, and/or its roaming partners.

As used herein, the terms “service signal,” “pilot signal,” “carrier frequency,” “carrier signal,” “beacon signal,” and “BCCH carrier frequency” are used interchangeably to describe a base frequency signal which a network broadcasts from a base transceiver station (BTS), radio base station (RBS), or node B in order to advertise its presence, operator identity, and other necessary initial information.

The term “camping” when used herein with respect to a cell or network refers to selecting a suitable cell of a selected PLMN by choosing an acquired service signal broadcasting an identifier of the selected PLMN and tuning to control channels of that cell.

As used herein, the terms “registration” and “attachment” when used herein with respect to a network or system refer to steps in which, a wireless device, having camped on a suitable cell, registers its presence in the network by performing particular messaging exchanges with one or more network entities (e.g., performing a location update, GPRS attach, or IMSI attach procedure in GSM). Reference herein to registration also encompasses successful completion of any necessary preceding steps defined by the applicable protocol standards (e.g., carrier channel acquisition, PLMN selection, cell selection and camping, etc. in GSM).

Wireless communication networks are widely deployed to provide various communication services such as voice, packet data, broadcast, messaging, and so on. These wireless networks may be capable of supporting communications for multiple users by sharing the available network resources. Examples of such wireless networks include the Global System for Mobile Communications (GSM), Code Division Multiple Access (CDMA) networks, Time Division Multiple Access (TDMA) networks, and Frequency Division Multiple Access (FDMA) networks. Wireless networks may also utilize various radio technologies such as Wideband-CDMA (W-CDMA), cdma2000, Global System for Mobile Communications (GSM), etc. While reference may be made to procedures set forth in GSM standards such references are provided merely as examples, and the claims encompass other types of cellular telecommunication networks and technologies.

In a multi-SIM device in which two or more SIMs are each associated with a radio resource (e.g., a DSDA device), the SIMs and their associated modem stacks may independently acquire and register for service with selected networks using the information stored in the respective SIMs. Depending on the particular communication protocols and/or radio access technologies of the selected networks, service acquisition and registration may include camping on a suitable cell of the network, and alerting the network of the presence in the serving cell. As a result of successfully registering in a network, the modem stack corresponding to a SIM may operate in idle mode until a call is receive or initiated. In an idle mode the modem stack may perform functions such as monitoring a paging channel and performing cell reselection and location updates as needed.

When a network in which a SIM is registered receives a mobile terminating (MT) call addressed to a SIM's Mobile Subscriber Integrated Services Digital Network-Number (MSISDN)—or a Mobile Station International Integrated Services Network Number depending on the type of network—a paging request may be broadcast on the paging channel of the network by all of the base stations in the location area. The modem stack associated with that SIM recognizes that the received paging request is directed to the SIM, and may request assignment of a dedicated traffic channel from the base station controller. Once a channel is assigned, a paging response may be sent from the SIM modem stack to the network. The response may be passed from the access network (i.e., base stations/base station controller) to a mobile switching center (MSC), which may authenticate the subscription information stored in the SIM by checking parameters with the home location register (HLR). Following authentication, a call setup may be sent to the wireless device, which may respond to indicate whether the particular call type is enabled by the information stored in the SIM. If so, the assigned traffic channel may be allocated and the call may commence by sending and receiving data using the radio resource associated with that SIM.

The embodiments may employ additional services offered by networks serving a multi-SIM device, such as those that allow a user to interact with multiple calls in a variety of ways. For example, the embodiments may use the Call Waiting (CW) and Call Holding (HOLD) supplementary services in GSM networks that are described, for example, in ETSI TS 100 516 version 7.0.0, entitled “Digital cellular telecommunications system (Phase 2+); Call Waiting (CW) and Call Holding (HOLD); Supplementary Services—Stage 1 (GSM 02.83 version 7.0.0 Release 1998).” As another example, the embodiments may use the Call Forwarding (CF) supplementary services in GSM networks that are described, for example, in ETSI EN 300 952 version 7.0.2, entitled “Digital cellular telecommunications system (Phase 2+); Call Forwarding (CF) supplementary services; Stage 3 (GSM 04.82 version 7.0.2 Release 1998).”

These and other supplementary services may provide user- or network-configurable options for receiving and placing calls. Specifically, for a call addressed to a SIM for which the modem stack is already participating in an active call, call waiting services may be invoked and the call may be offered to the user with an appropriate indication (i.e., a call waiting tone). Call holding services may be invoked to accept the new incoming call before expiration of a no-answer time out period by interrupting communications on the existing active call to answer the new incoming call, subsequently re-establishing the communication with the held call and retaining the assigned traffic channel after the call is interrupted. For example, the call waiting and call holding services may be enabled based on information stored in a SIM provisioned by a network operator providing the service subscription associated with the SIM.

In this manner, in a DSDA wireless device each radio resource associated with a SIM and its corresponding modem stack may operate as an independent device, despite being co-located and sharing non-network based resources with one another (e.g., user input/output resources, general processor and storage, etc.). While such independent functionality provides multiple user benefits, such as providing the user with essentially multiple different phones in the same physical housing, in some scenarios a device may benefit from cooperatively using the services enabled by information stored in multiple SIMs. In particular, when a radio resource associated with one SIM is engaged in a maximum number of active calls enabled by the services (e.g., call waiting) of the network, any subsequent incoming communications to the MSISDN of that SIM are generally unsuccessful unless one of the active communications on the first SIM is dropped. Since the SIM modem stacks are configured to operate independently, even if the radio resource associated with another SIM is available on the wireless device, such resource typically remains unused to handle the incoming call.

The various embodiments provide methods for increasing the number of simultaneous calls on a single SIM (i.e., to/from the number associated with that SIM) of a multi-SIM device that is configured with multiple corresponding radio resources. In particular, when a wireless device processor determines that a first SIM modem stack is currently handling two ongoing calls (e.g., one active call and one held call using call waiting and/or call holding services), the processor may determine whether the modem stack associated with another SIM of the wireless device is currently handling less than two calls (e.g., in idle mode and handling no calls, or in connected mode handling only one active or held call). When that is the case, the wireless device processor may automatically trigger a call forwarding service on the network serving the first SIM modem stack. While call forwarding functionality is activated, if the network of the first SIM receives instructions to broadcast a paging request for a new incoming call addressed to the first SIM, the new incoming call may be re-addressed to an identifier of the second SIM, and routed to the network in which the second SIM modem stack has registered. In this manner, the new incoming call may be received on the wireless device by the radio resource associated with the second SIM, and handled by the corresponding second SIM modem stack. In the various embodiments, call waiting and call holding services may also be enabled by the information on the second SIM such that up to two additional incoming calls to the first SIM (i.e., a third and fourth incoming call) may be forwarded to the IMSI associated with the second SIM. The various embodiments thus enable the wireless device to maintain more than the maximum number of pending calls supported by the network associated with one SIM without requiring any changes to the network or wireless technology standards.

In the various embodiments, when one or both of the calls on the first SIM is terminated so that the first SIM becomes available to accept a new incoming call, the wireless device may transmit to the network of the first SIM a deregistration signal to deactivate the call forwarding functionality. The wireless device processor may also automatically transmit a deregistration signal to deactivate the call forwarding functionality in response to determining that the maximum number of calls are pending on the second SIM such that the second SIM would not be able to receive a forwarded call. As a result of deactivation of call forwarding, normal call processing is restored such that new incoming calls to the MSISDN first SIM may be handled by the modem stack and radio resource associated with the first SIM. Further, deactivation of call forwarding in the network associated with the first SIM may not impact calls presently connected via the second SIM, so a call forwarded to the second SIM would be allowed to continue after call forwarding is deactivated. Thus, if call forwarding is deactivated on the first SIM due to one call terminating when another call is maintained on the first SIM and a forwarded call is maintained on the second SIM, a third incoming call would be received on the first SIM. Also, activating call forwarding on the network associated with the first SIM does not change the operating mode of the second SIM. Thus, even while call forwarding on the network associated with the first SIM is activated, the radio access technology associated with the second SIM will remain in idle mode until a call is received or originated, and listen for paging requests from the network associated with the second SIM in the normal manner.

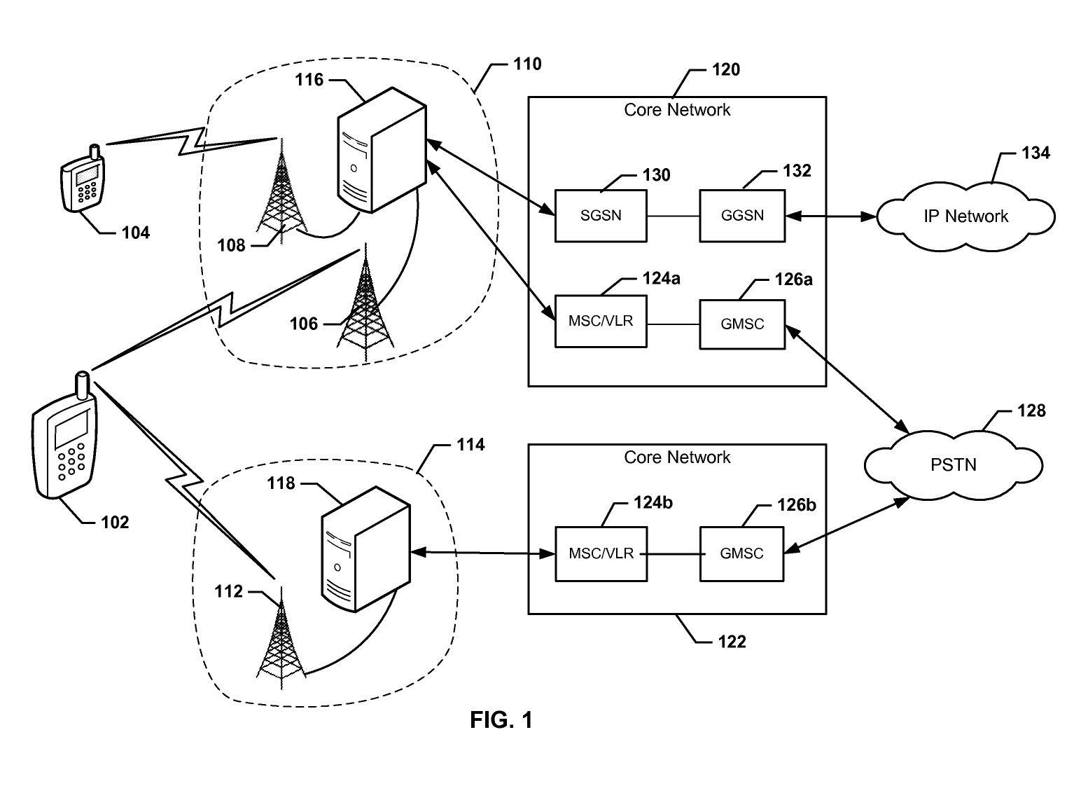

FIG. 1 illustrates a wireless network system 100 suitable for use with the various embodiments. Wireless devices 102, 104 may be configured to establish wireless connections with cell towers or base stations of one or more radio access networks. For example, wireless devices 102, 104 may transmit/receive data using base stations 106, 108, which may be part of a network 110, as is known in the art. Wireless device 102 may further be configured to transmit/receive data through base station 112, which may be part of a different network 114. The wireless networks 110, 114 may be cellular data networks, and may use channel access methods including, but not limited to, Global System for Mobile Communications (GSM), Universal Mobile Telecommunications Systems (UMTS) (particularly, Long Term Evolution (LTE)), Frequency Division Multiple Access (FDMA), Time Division Multiple Access (TDMA), Code Division Multiple Access (CDMA), Wi-Fi, PCS, G-3, G-4, or other protocols that may be used in a wireless communications network or a data communications network. The networks 110, 114 may also be referred to by those of skill in the art as access networks, radio access networks, base station subsystems (BSSs), UMTS Terrestrial Radio Access Networks (UTRANs), etc. Networks 110, 114 may use the same or different wireless interfaces and/or physical layers. In an embodiment, base stations 106, 108, 112 may be controlled by one or more base station controllers (BSC) 116, 118. For example, base stations 106, 108, BSC 116, and other components may form network 110, as is known in the art. Alternate network configurations may also be used and the embodiments are not limited to the configuration illustrated. For example, in another embodiment the functionality of the BSC 116 and at least one of base stations 106, 108 may be collapsed into a single “hybrid” module having the functionality of these components.

In the various embodiments, a wireless device 102 may simultaneously access core networks 120, 122 after camping on cells managed by base stations 106, 112. Each core network 120, 122 may provide various services to the wireless device 102 via respective connections to networks 110, 114. In various embodiments, core networks 120, 122 may each include a circuit-switched (CS) domain. Examples of circuit-switched entities that may be part of core networks 120, 122 include a mobile switching center (MSC) and visitor location register (VLR), identified as MSC/VLRs 124a, 124b, as well as Gateway MSCs (GMSCs) 126a, 126b. Core networks 120, 122 may be interconnected by connections from respective GMSCs 126a, 126b to the public switched telephone network (PSTN) 128, across which the core networks 120, 122 may route various incoming and outgoing communications to the wireless device 102.

One or more core networks, such as core network 120, may also include a packet-switched (PS) domain. Example packet-switched elements that may be part of core network 120 include a Serving GPRS Support Node (SGSN) 130 and a Gateway GPRS Support Node (GGSN) 132. The GGSN 132 may be connected to an IP network 134, across which core network 120 may route IP data traffic to and from the wireless device 102. Other network entities (not shown) that may be part of the core network 120 may include an Equipment Identity Register (EIR), Home Location Register (HLR), and Authentication Center (AuC), some or all of which may be shared by both the circuit-switched and packet-switched domains.

A wireless device 102 may also establish connections with Wi-Fi access points, which may connect to the Internet. While the various embodiments are particularly useful with wireless networks, the embodiments are not limited to wireless networks and may also be implemented over wired networks with no changes to the methods.

In a wireless network system 100, a wireless device 102 may be a multi-SIM wireless communication device that is capable of operating with a number of wireless networks enabled by information stored in a plurality of SIMs. Using dual-SIM functionality, the wireless device 102 may simultaneously access two core networks 120, 122 by camping on cells managed by base stations 106, 112. For example, a multi-SIM wireless device 102 may make a voice or data call to a third party device, such as wireless device 104, using a service enabled by information stored in a first one of the SIMs, as well as the protocol stack associated with that SIM, via a first one of the radio resources. The multi-SIM wireless device 102 may also simultaneously receive a voice call or other data transmission from a third party in a similar manner using a service enabled by information stored in second of the SIMs, as well as the protocol stack associated with that SIM, via a second radio resource. The third party device (e.g., wireless device 104) may be any of a variety of devices, including, but not limited to, a mobile phone, laptop computer, PDA, server, etc.).

Some or all of the wireless devices 102, 104 may be configured with multi-mode capabilities and may include multiple transceivers for communicating with different wireless networks 120, 122 over different wireless links/radio access technologies. For example, a DSDA wireless device 102 may be configured to camp two SIMs on cells of two different networks though separate transmit/receive chains (i.e., independent radio resources) and communicate over the two wireless data networks on different subscriptions. For example, while the techniques and embodiments described herein relate to a wireless device configured with at least one GSM subscription, they may be extended to subscriptions on other radio access networks (e.g., cdma2000, UMTS, WCDMA, LTE, etc.).

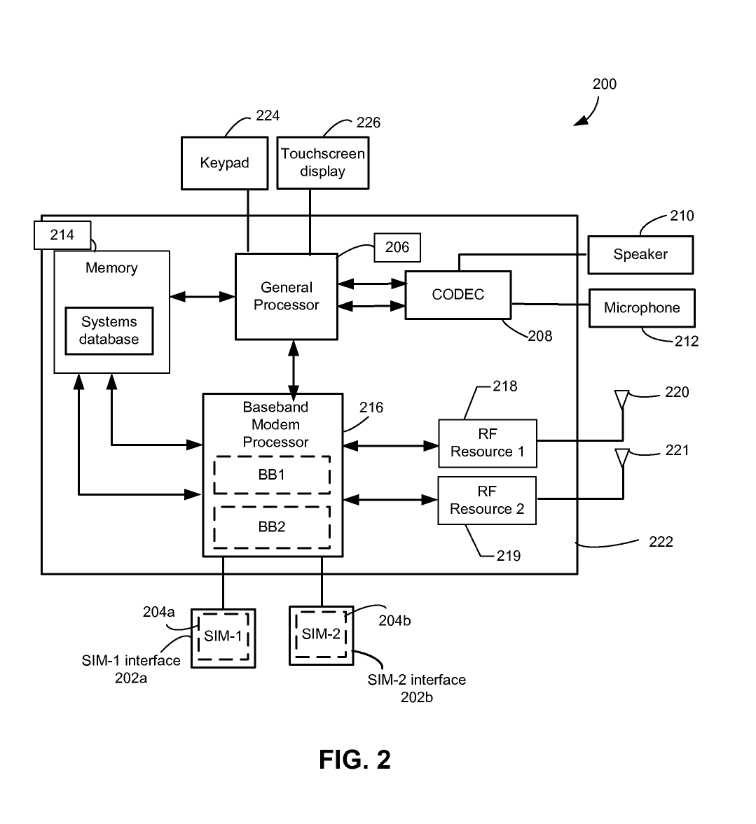

FIG. 2 is a functional block diagram of an example DSDA multi-SIM wireless device 200 that is suitable for implementing the various embodiments. The wireless device 200 may include a first SIM interface 202a, which may receive a first identity module SIM 204a that is associated with the first subscription. The wireless device 200 may also include a second SIM interface 202b, which may receive a second identity module SIM 204b that is associated with the second subscription.

A SIM in the various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. A SIM 204a, 204b used in the various embodiments may contain user account information, an IMSI a set of SIM application toolkit (SAT) commands and storage space for phone book contacts. A SIM 204a, 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID)

A multi-SIM wireless device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. Memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions.

The general purpose processor 206 and memory 214 may each be coupled to at least one baseband modem processor 216. Each SIM 204a, 204b in the wireless device 200 may be associated with a baseband-RF resource chain that includes a baseband modem processor 216 and a radio resource/RF resource 218, 219. The RF resources 218, 219 may be coupled to an antenna 220, 221, and may perform transmit/receive functions for the wireless services associated with each SIM 204a, 204b of the wireless device. In an embodiment, the RF resources 218, 219 may be coupled to wireless antennas 220, 221 for sending and receiving RF signals, providing separate transmit and receive functionality for the SIMs 204a, 204b thereby enabling the wireless device to perform simultaneous communications with separate networks and/or service associated with the SIMs, or may include a transceiver that combines transmitter and receiver functions.

In a particular embodiment, the general purpose processor 206, memory 214, baseband modem processor(s) 216, and RF resource(s) 218 may be included in a system-on-chip device 222. The first and second SIMs 204a, 204b and their corresponding interfaces 202a, 202b may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In an embodiment, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in wireless device 200 to enable communication between them, as is known in the art.

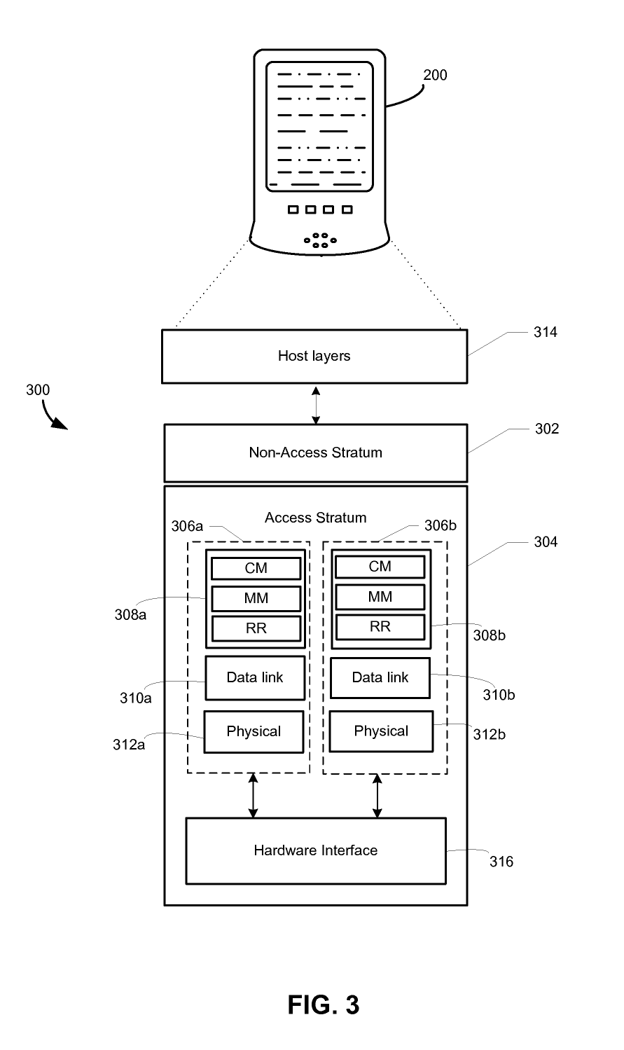

Referring to FIG. 3, a wireless device 200 may have a layered software architecture 300 to communicate over access networks associated with SIMs. The software architecture 300 may be distributed among one or more processors, such as baseband modem processor(s) 216. The software architecture 300 may also include a Non Access Stratum (NAS) 302 and an Access Stratum (AS) 304. The NAS 302 may include functions and protocols to support traffic and signaling between SIMs of the wireless device 200 (e.g., SIM 204a, SIM-2 204b) and their respective core networks. The AS 304 may include functions and protocols that support communication between the SIMs 204a, 204b, and entities of their respective access networks (such as a MSC if in a GSM network).

In the multi-SIM wireless communication device 200, the AS 304 may include multiple protocol stacks, each of which may be associated with a different SIM. The protocol stacks may be implemented to allow modem operation using information provisioned on multiple SIMs. Therefore, a protocol stack that may be executed by a baseband modem processor is interchangeably referred to herein as a modem stack.

In an example embodiment, the AS 304 may include protocol stacks 306a, 306b, associated with SIMs 204a, 204b, respectively. Although described below with reference to GSM-type communication layers, protocol stacks 306a, 306b may support any of variety of standards and protocols for wireless communications. The protocol stacks 306a, 306b may respectively include mobile radio interface signaling layers 308a, 308b, which may each be implementations of Layer 3 of a GSM signaling protocol. Further, each signaling layer 308a, 308b may include at least one sublayer. For example, the connection management (CM) sublayers may manage call control functions for circuit-switched communications in the network, such as establishing, maintaining and releasing call connections for communications. The CM sublayer may also manage supplementary services and SMS communications.

Residing below the CM sublayers in signaling layers 308a, 308b, the mobility management (MM) sublayers may support the mobility of user devices, and providing connection management services to the respective CM sublayer functions arising from mobility of the user, as well as authentication and security. Example functions of the mobility management sublayers may include provision of a MM connection, based on an existing radio resource connection, to the corresponding CM sub layer, location update procedures, and IMSI attach and detach procedures. Residing below the MM sublayers, the radio resource management (RR) sublayers may oversee the establishment of links between the wireless device 200 and associated access networks, including management of the frequency spectrum, channel assignment and handover, power-level control, and signal measurements. In the various embodiments, the NAS 302 and RR layers may perform the various functions to search for wireless networks and to establish, maintain and terminate calls.

Residing below the signaling layers 308a, 308b, protocol stacks 306a, 306b may also include data link layers 310a, 310b, which may be part of Layer 2 in a GSM signaling protocol. Data link layers 310a, 310b may provide functions to handle incoming and outgoing data across the network, such as dividing output data into data frames and analyzing incoming data to ensure it has been successfully received. In an embodiment, each data link layer 310a, 310b may contain various sub-layers (e.g., media access control (MAC) and logical link control (LLC) layers (not shown)). Residing below the data link layers 310a, 310b, protocol stacks 306a, 306b may also include physical layers 312a, 312b, which may establish connections over the air interface and manage network resources for the wireless device 200.

While the protocol stacks 306a, 306b provide functions to transmit data through physical media, the software architecture 300 may further include at least one host layer 314 to provide data transfer services to various applications in the wireless device 200. In an embodiment, application-specific functions provided by the at least one host layer 314 may provide an interface between the protocol stacks 306a, 306b and the general purpose processor 202. In an alternative embodiment, the protocol stacks 306a, 306b may each include one or more higher logical layers (e.g., transport, session, presentation, application, etc.) that provide host layer functions. In an embodiment, the software architecture 300 may further include in the AS 304 a hardware interface 316 between physical layers 312a, 312b and the communication hardware (e.g., one or more RF transceivers).

Separate units of the baseband-modem processor of the multi-SIM device may be implemented as separate structures or as separate logical units within the same structure, and may be configured to execute software including at least two protocol/modem stacks associated with at least two SIMs, respectively. The SIMs and associated modem stacks may be configured to support a variety of communication services that fulfill different user requirements. Further, a particular SIM may be provisioned with information to execute different signaling procedures for accessing a domain of the core network associated with these services and for handling data thereof

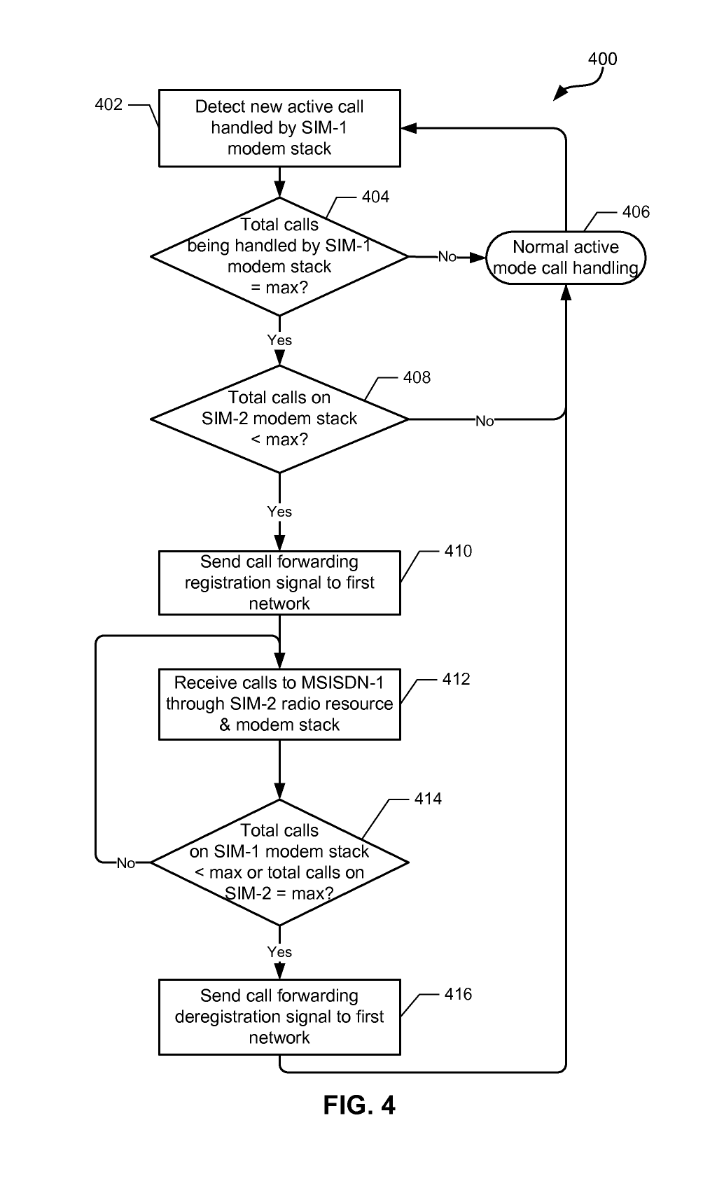

FIG. 4 illustrates an embodiment method 400 of managing a dynamic call forwarding mechanism to increase the maximum number of calls associated with one SIM that may be simultaneously received on a DSDA device. The operations of method 400 may be implemented by one or more processors of the wireless device, such as the general purpose processor 206 and/or baseband modem processor(s) 216 as shown in FIG. 2, or a separate controller (not shown) that may be coupled to memory and to the baseband modem processor(s) 216.

In block 402, the wireless device processor may detect that a new active communication (i.e., mobile terminating or mobile originating call) has started, and that the modem stack associated with a first SIM (“SIM”) is handling the new active call on its corresponding radio resource. The detection of the new active communication may be performed in any of a number of ways. For example, the wireless device processor may be configured to receive an alert when a CM sublayer of one of the SIM modem stacks receives a “call connect” message from its network indicating that a pending mobile terminating or initiated mobile originating call has been established. Further, the wireless device processor may maintain, for each SIM, a counter of the total ongoing calls currently being handled on the corresponding modem stack.

In determination block 404, the wireless device processor may determine whether the total number of ongoing calls being handled by the CM sublayer of the first SIM modem stack is equal to a preset maximum number established by the network providing service to the first SIM (“first network”). In an embodiment, the first network may establish a maximum number as two ongoing calls (e.g., one active call and one held call). If the number of ongoing calls that are being handled by the CM sublayer for the first SIM is not equal to the preset maximum number (i.e., determination block 404=“No”), in block 406 the wireless device processor may continue in a normal active mode handling of the detected new call(s).

If the number of ongoing calls being handled by the CM sublayer for the first SIM equals the preset maximum number (i.e., determination block 404=“Yes”), in determination block 408, the wireless device processor may determine whether the number of calls being handled by the CM sublayer of the second SIM modem stack is less than a preset maximum number established by the network providing service to the second SIM (“second network”), which may be different or the same as the preset maximum number for the first network. For example, the second network may establish a maximum number as two ongoing calls (e.g., one active call and one held call). Note that if the second SIM radio resource is in idle mode (i.e., with no active calls), the number of ongoing calls being handled by the CM sublayer of the second SIM modem stack would automatically be less than the preset maximum number because the count would be zero. An idle mode determination may be made, for example, based on information obtained from the signaling layer of the second SIM modem stack (e.g., the state of the RR sublayer), or based on activity of the second SIM radio resource using information from one or more of the lower layers (e.g., data link and/or physical layers). If the second SIM radio resource is in connected mode, the total number of ongoing (i.e., active and held) calls may be determined, for example, from signaling of the CM sublayer for the second SIM.

If the total number of ongoing (e.g., active and held calls) calls being handled by the CM sublayer of the second SIM modem stack is not less than the preset maximum number (i.e., determination block 408=“No”), the wireless device processor may continue in the normal active mode handling the ongoing call(s) by the first SIM modem stack block 406. If the total number of ongoing (e.g., active and held calls) calls being handled by the CM sublayer for the second SIM is less than the preset maximum number, (i.e., determination block 408=“Yes”), the wireless device processor may transmitting a registration request message or otherwise send a signal to the first network to activate call forwarding on the network associated with the first SIM to forward calls to the phone number associated with the second SIM in block 410. For example, in a GSM network, the call registration signal may be a Call Forwarding Unconditional (CFU) registration request. In various embodiments, the CFU registration request may include the IMSI or the MSISDN associated with the second SIM (“MSISDN-2”). Assuming acceptance and/or acknowledgment of the registration signal by the network serving the first SIM, the call forwarding functionality may be activated and in block 412 the wireless device may receive calls addressed to the MSISDN of the first SIM (“MSISDN-1”) through the radio resource associated with the second SIM, with the calls handled by the CM sublayer of the corresponding modem stack. For example, if the radio resource associated with the second SIM is in idle mode, then upon activation of the call forwarding functionality a forwarded call may be handled by the CM sublayer of the second SIM modem stack as if it were an active call addressed to the MSISDN of the second SIM. In another example, if the radio resource associated with the second SIM is in connected mode with the associated CM sublayer already handling an ongoing active call, then upon activation of the call forwarding functionality, the CM sublayer of the second SIM modem stack may handle a forwarded call using call waiting and call holding supplementary services to accommodate both the original and forwarded calls (i.e., one active and one held),In determination block 414, the wireless device processor may determine whether the total number of ongoing (i.e., active and held) calls currently being handled by the modem stack of the first SIM is less than the preset maximum number (e.g., two calls) established by the first network. In an embodiment, this determination may be performed periodically while the call forwarding functionality is activated, for example, upon expiration of a repeating countdown timer. In another embodiment, this determination may be triggered based on detecting or receiving notification of a call termination on the CM sublayer of the first SIM modem stack.

In an embodiment, as part of determination block 414, the wireless device processor may also determine whether the total number of ongoing (i.e., active and held) calls currently being handled by the modem stack of the second SIM is equals the preset maximum number (e.g., two calls) established by the second network. If the modem stack of the second SIM is handling the preset maximum number of calls then that modem stack could not accept a forwarded call, therefore deactivating call forwarding may enable the network associated with the first SIM to handle another call (e.g., recording a voice message).

If the total number of calls being handled by the first SIM modem stack is not less than the preset maximum number, and the number of calls being handled by the modem stack of the second SIM is not equal to the preset maximum number (i.e., determination block 414=“No”), call forwarding may remain active and the wireless device processor may continue to receive and handle calls addressed to MSISDN-1 on the radio resource and modem stack associated with the second SIM in block 412.

If the number of calls being handled by the first SIM modem stack is less than the maximum (e.g., one or both calls on the first SIM ends) or the number of calls being handled by the modem stack of the second SIM equals the preset maximum number (i.e., determination block 414=“Yes”), in block 416 the wireless device processor may send a signal to the first network to deregister the call forwarding functionality, thereby reverting the wireless device to normal handling of incoming calls in block 406 (i.e., handling by the modem stack and radio resource associated with the identifier to which calls may be addressed).

The operations in method 400 may be performed continuously as the wireless device processor may return to block 402 upon detecting a new active communication being handled by a modem stack corresponding to the same or a different “first SIM” on the wireless device in block 402. For example, if deregistration occurred because the total number of calls being handled by the second SIM was equal to the maximum, but one of the calls is subsequently terminated on the second SIM while the number of calls on the first SIM modem stack is still at its maximum, the wireless device processor may reregister the call forwarding functionality on the network associated with the first SIM to forward calls to the telephone number associated with the second SIM in block 410 by again sending a signal to the first network reregistering the call forwarding to the second SIM, block 410

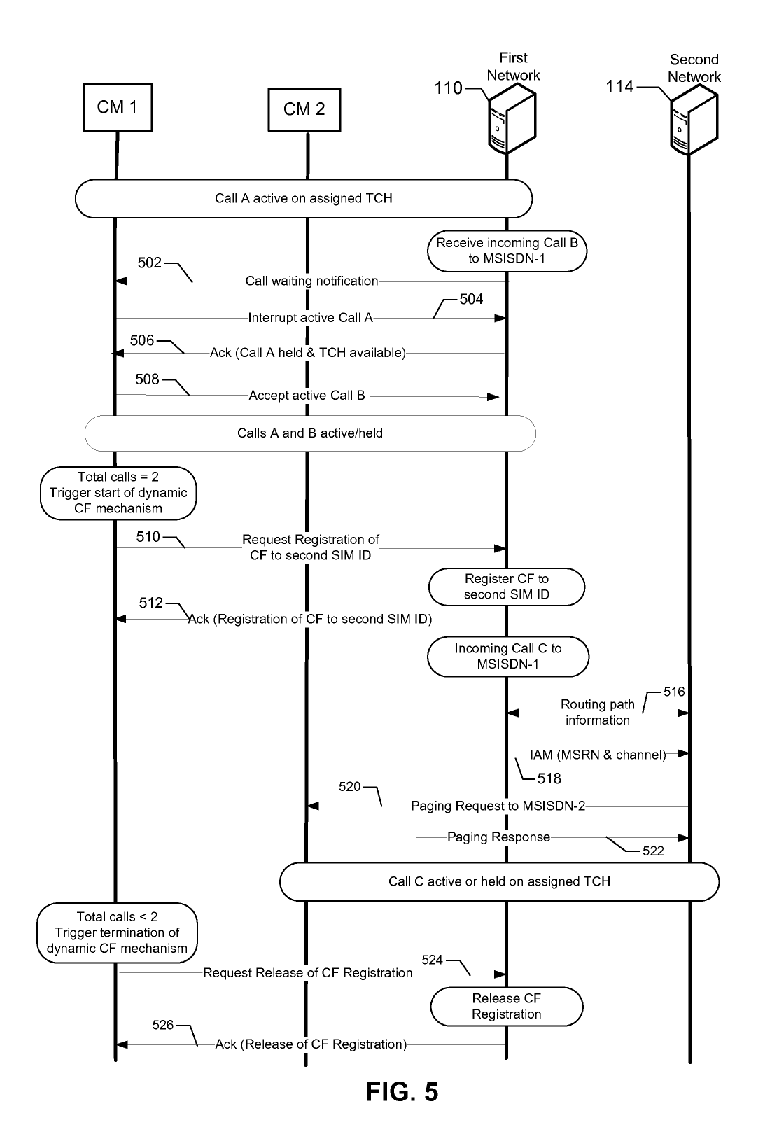

FIG. 5 is a message flow diagram illustrating example messages that may be used to dynamically implement the call forwarding mechanism on a DSDA device when the number of calls pending on a first SIM equals a maximum number.

In the various embodiments, a CM sublayer of the signaling layer in each modem stack may operate to manage supplementary services, including call waiting, call holding, and call forwarding that may be used to implement such simultaneous call handling. For example, the CM sublayer of the modem stack of a first SIM (“CM1”) may be engaged in an active communication (“Call A”) using a traffic channel assigned to it by a network providing service to the first SIM (e.g., first network).

Upon arrival of an incoming call (“Call B”) addressed to a first SIM identifier (e.g., to MSISDN-1), a component of the first network (e.g., network 110) may determine that the traffic channel assigned to the first SIM is unavailable because of ongoing active Call A. The network component may be, for example, a base station 106, 108, a BSC 116, and/or any of a variety of other network entities that may directly or indirectly perform call setup functions for a SIM of wireless device 200.

The first network may invoke the call waiting service and send a call waiting notification to CM1 in message 502. Based on user input, CM1 may invoke the call holding service by sending a message 504 to the first network to interrupt the connection of active Call A. The first network may place Call A on hold and send a message 506 to CM1 that may acknowledge, for example, the held state of Call A and the availability of the traffic channel assigned to SIM. Based on user input selecting to accept call B, CM1 may send a message 508 to the first network to accept waiting Call B as an active call on the assigned traffic channel. As a result, CM1 may be engaged in a total of two ongoing calls, and may thereafter alternate Calls A and B between the active and held states.

Assuming that the maximum number of ongoing calls is set at two by the first network operator, the simultaneous handling of two ongoing calls by CM1 may trigger the call forwarding mechanism. In particular, CM1 may send to the first network a message 510 requesting registration of a call forwarding (CF) service to forward incoming calls to an identifier associated with the second SIM. In an example, the requested call forwarding service may be the Call Forwarding Unconditional supplemental service in a GSM network, and the identifier associated with the second SIM may included as a “ForwardedToNumber” parameter of message 510. In an embodiment, such identifier may be the IMSI of the second SIM, which may be provided to CM1 from memory that is directly accessible to the baseband-modem processor on which the first SIM modem stack is implemented, or provided indirectly from a controller configured to access information on both the first and second SIMs. In an alternative embodiment, the identifier associated with the second SIM that is included in message 510 may be a MSISDN of the second SIM (e.g., MSISDN-2), which the HLR may use to obtain the IMSI of the second SIM when a call is forwarded, as discussed below.

If the registration is successful, the CF service may be registered and activated, and the first network may send an acknowledgement message 512 indicating acceptance of the request.

Upon arrival of another incoming call (“Call C”) addressed to MSISDN-1, the first network may exchange messages 516 with components of a network in which the second SIM is registered (e.g., second network) to establish routing path information to forward Call C to the second SIM. These messages may establish routing path information to allow the call forwarding mechanism to forward the Call C to the second SIM.

The second network may include components of an access network (e.g., network 114) such as a base station 112, BSC 118, and/or any of a variety of other entities that may directly or indirectly perform call setup functions for a SIM of wireless device 200. Further, in the various embodiments components of the first and second networks 110, 114 that may participate in messages 516 exchanged between networks to route forwarded calls may include various core network entities such as MSC/VLRs, GMSCs, an HLR, etc. For example, a first network MSC may request a mobile station routing number (MSRN) that may have been allocated to the second SIM by the second network MSC currently providing service to the second SIM. To obtain this information, the HLR may determine the second network MSC, as well as the second SIM IMSI if not included in the CF registration request from CM1, The HLR may request, and the second network MSC may return, an MSRN for the second SIM, which the HLR may provide to the first network MSC. The first network MSC may check a routing table to resolve a routing path to that MSRN, and communication may be established between the first and second network MSCs via an initial addressing message (IAM) 518 identifying the MSRN and the traffic channel allocated for Call C.

Upon receiving the IAM 518, the second network MSC may determine a location area of the second SIM, and may resolve base station entities (e.g., base station controllers and/or base transceiver stations) within that location area. All base stations of the second network within that determined location area may broadcast a paging request 520 for a mobile terminating Call C addressed to a second SIM identifier (e.g., IMSI or TMSI of the second SIM). Once the paging request is received by the CM sublayer of the second SIM modem stack (“CM2”), a paging response message 522 may be sent to the second network. Based on user input selecting to accept Call C, Call C may proceed as an active call in which data traffic may be sent and received using the radio resource corresponding to the second SIM. If CM2 is already handling one active call, Call C may be offered to CM2 while that existing call remains in progress using the call waiting and call holding services described above with respect to Calls A and B on CM. In various embodiments, steps implementing the messaging associated with Call C may be repeated for another incoming Call D addressed to MSISDN-1, which may be offered to CM2 while Call C remains in progress using the call waiting and call holding services as described above with respect to Calls A and B on CM1.

If one or both of ongoing Calls A and B is terminated, the total number of ongoing calls being handled by CM 1 may be below the maximum number established by the first network, which may trigger termination of the dynamic call forwarding mechanism to be started. CM1 may send a deregistration message 524 to the first network requesting release of the registered call forwarding service so that incoming calls are no longer forwarded to the second SIM modem stack. The CF service registration may be released on the first network, and the first network may send a message 526 to CM1 acknowledging the release of the registered call forwarding service. Termination of the dynamic call forwarding mechanism may alternatively be triggered by CM2 if the total number of ongoing calls being handled by CM2, including calls that were forwarded as well as any calls to or originating on CM2, reaches the maximum number established by the second network (not shown).

The various messages exchanged between a serving network and the CM sublayer of one of the SIM modem stacks to implement supplementary services may be Unstructured Supplementary Service Data (USSD) messages. In the various embodiments, such USSD messages may be transmitted and received over a control channel (e.g., FACCH or SACCH) associated with the logical traffic channel used for the voice call. Such a control channel may be a dedicated control channel associated with the traffic channel.

As discussed above, access networks 110 and 114 are provided merely as examples of the first and second networks, which may represent any of a variety of entities on.

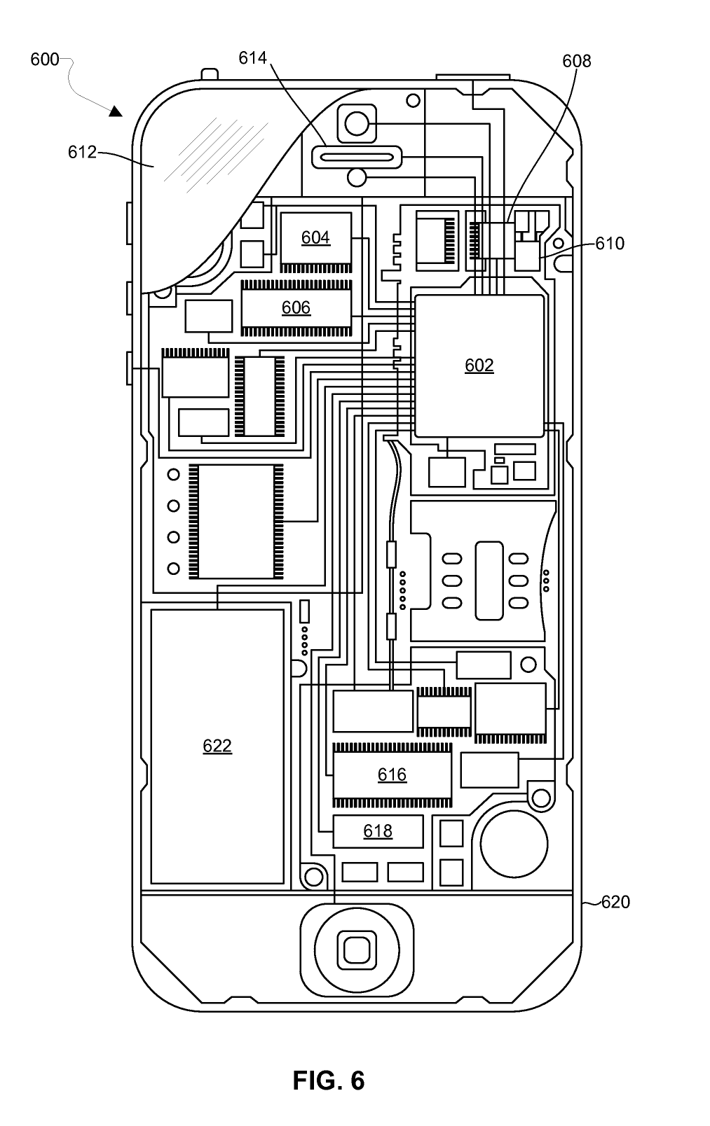

The various embodiments may be implemented in any of a variety of wireless devices, an example of which is illustrated in FIG. 6. For example, the wireless device 600 may include a processor 602 coupled to a touchscreen controller 604 and an internal memory 606. The processor 602 may be one or more multicore ICs designated for general or specific processing tasks. The internal memory 606 may be volatile or non-volatile memory, and may also be secure and/or encrypted memory, or unsecure and/or unencrypted memory, or any combination thereof

The touchscreen controller 604 and the processor 602 may also be coupled to a touchscreen panel 612, such as a resistive-sensing touchscreen, capacitive-sensing touchscreen, infrared sensing touchscreen, etc. The wireless device 600 processor 602 may be coupled to two or more radio signal transceivers 608, 616 and antennae 610 that enable communications via two or more cellular networks for sending and receiving voice and data calls. The transceivers 608, 616 and antennae 610 may be used with the above-mentioned circuitry to implement the various wireless transmission modem stacks and interfaces.

The multicore device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The multicore device 600 may also include speakers 614 for providing audio outputs. The multicore device 600 may also include a housing 620, constructed of a plastic, metal, or a combination of materials, for containing all or some of the components discussed herein. The multicore device 600 may include a power source 622 coupled to the processor 602, such as a disposable or rechargeable battery. The rechargeable battery may also be coupled to the peripheral device connection port to receive a charging current from a source external to the multicore device 600.

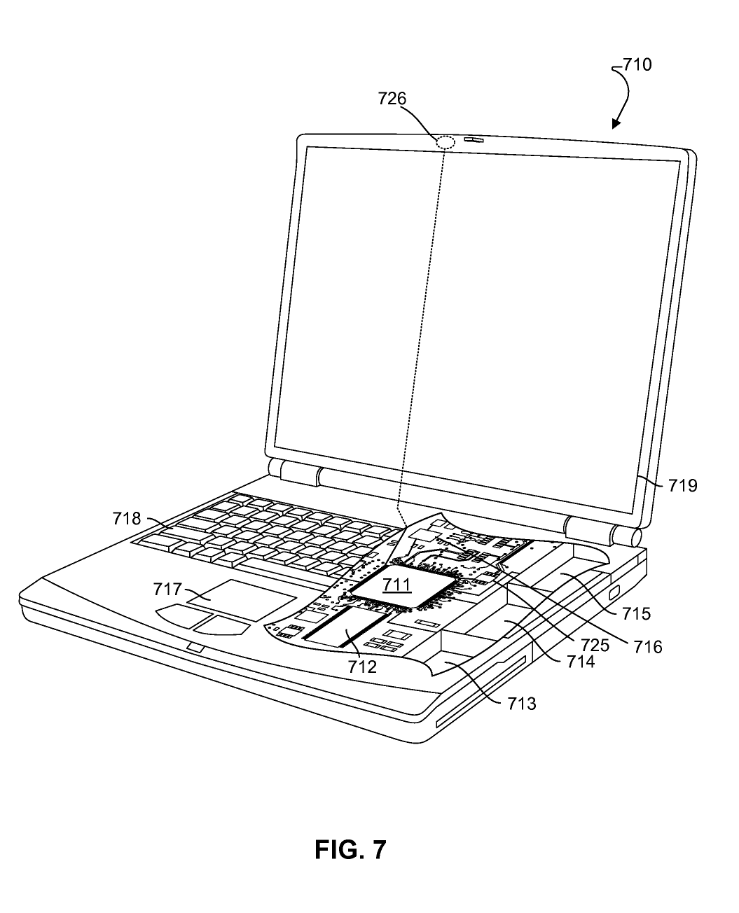

The various embodiments described above may also be implemented within a variety of personal computing devices, such as a laptop computer 700 as illustrated in FIG. 7. Many laptop computers include a touch pad touch surface 717 that serves as the computer's pointing device, and thus may receive drag, scroll, and flick gestures similar to those implemented on wireless computing devices equipped with a touch screen display and described above. A laptop computer 700 will typically include a processor 711 coupled to volatile memory 712 and a large capacity nonvolatile memory, such as a disk drive 713 of Flash memory. The computer 700 may also include a floppy disc drive 714 and a compact disc (CD) drive 715 coupled to the processor 711. The computer 700 may also include a number of connector ports coupled to the processor 711 for establishing data connections or receiving external memory devices, such as a USB or FireWire® connector sockets, or other network connection circuits for coupling the processor 711 to a network. In a notebook configuration, the computer housing includes the touchpad 717, the keyboard 718, and the display 719 all coupled to the processor 711. Other configurations of the computing device may include a computer mouse or trackball coupled to the processor (e.g., via a USB input) as are well known, which may also be use in conjunction with the various embodiments.

The processors 602, 711 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 606, 712, 713 before they are accessed and loaded into the processors 602, 711. Processors 602, 711 may include internal memory sufficient to store the application software instructions. In many devices the internal memory may be a volatile or nonvolatile memory, such as flash memory, or a mixture of both. For the purposes of this description, a general reference to memory refers to memory accessible by the processors 602, 711 including internal memory or removable memory plugged into the wireless device and memory within the processor 602, 711, themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more embodiments, the functions described may be implemented in hardware, software, firmware, or any combination thereof If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of increasing capacity for handling simultaneous calls on a multi-SIM wireless communication device having at least a first subscriber identification module (SIM) associated with a first radio resource and a second SIM associated with a second radio resource, comprising:
monitoring a count of total ongoing calls being handled on each of a first modem stack and a second modem stack, wherein the first and second modem stacks are respectively associated with the first and second SIMs;
determining whether the count of total ongoing calls being handled on the first modem stack is equal to a first preset maximum count value established by a first network whose provisioning information is stored on the first SIM;
determining whether the count of total ongoing calls being handled on the second modem stack is less than a second preset maximum count value established by a second network whose provisioning information is stored on the second SIM in response to determining that the count of total ongoing calls being handled on the first modem stack is equal to the first preset maximum count value; and
sending a signal to the first network activating a call forwarding function to forward additional calls to the second radio resource in response to determining that the count of total ongoing calls being handled on the second modem stack is less than the second preset maximum count value.

2. The method of claim 1, wherein:
the count of total ongoing calls being handled on the first modem stack comprises a sum of active and held calls on the first modem stack; and
the count of total ongoing calls being handled on the second modem stack comprises a sum of active and held calls on the second modem stack.

3. The method of claim 2, wherein the first preset maximum count value established by the first network comprises two calls, wherein the first modem stack is capable of handling two ongoing calls by invoking supplementary call waiting and call holding services provided by the first network.

4. The method of claim 2, wherein sending a signal to the first network activating the call forwarding function to forward additional calls to the second radio resource comprises:
transmitting a registration request message to the first network using a control channel associated with a traffic channel, wherein:
the registration request message contains an identifier associated with the second SIM and an instruction to forward incoming calls addressed to the first SIM to the second SIM using the identifier; and
the traffic channel is assigned by the first network for active calls handled by the first modem stack; and
receiving from the first network an acknowledgment of call forwarding registration.

5. The method of claim 1, further comprising:
determining whether the count of total ongoing calls being handled on the first modem stack is less than the first preset maximum count value; and
sending to the first network a request to deactivate the call forwarding function in response to determining that the count of total ongoing calls being handled on the first modem stack is less than the first preset maximum count value.

6. The method of claim 5, wherein the request to deactivate the call forwarding function contains an identifier associated with the second SIM and an instruction to cease forwarding of incoming calls addressed to the first SIM.

7. The method of claim 1, further comprising:
determining whether the count of total ongoing calls being handled on the second modem stack equals the second preset maximum count value; ; and sending to the first network a request to deactivate the call forwarding function in response to determining that the count of total ongoing calls being handled on the second modem stack equals the second preset maximum count value.

8. A wireless communication device, comprising:
a first radio resource;
a second radio resource;
a first subscriber identification module (SIM) associated with the first radio resource;
a second SIM associated with the second radio resource;
a processor coupled to the at least first and second radio resources and the first SIM, and the second SIM, wherein the processor is configured with processor-executable instructions to perform operations comprising:
monitoring a count of total ongoing calls being handled on each of a first modem stack and a second modem stack, wherein the first and second modem stacks are respectively associated with the first and second SIMs;
determining whether the count of total ongoing calls being handled on the first modem stack is equal to a first preset maximum count value established by a first network whose provisioning information is stored on the first SIM;
determining whether the count of total ongoing calls being handled on the second modem stack is less than a second preset maximum count value established by a second network whose provisioning information is stored on the second SIM in response to determining that the count of total ongoing calls being handled on the first modem stack is equal to the first preset maximum count value; and
sending a signal to the first network activating a call forwarding function to forward additional calls to the second radio resource in response to determining that the count of total ongoing calls being handled on the second modem stack is less than the second preset maximum count value.

9. The wireless communication device of claim 8, wherein the processor is configured with processor-executable instructions to perform operations such that:
the count of total ongoing calls being handled on the first modem stack comprises a sum of active and held calls on the first modem stack; and
the count of total ongoing calls being handled on the second modem stack comprises a sum of active and held calls on the second modem stack.

10. The wireless communication device of claim 9, wherein the processor is configured with processor-executable instructions to perform operations such that the first preset maximum count value established by the first network comprises two calls, wherein the first modem stack is capable of handling two ongoing calls by invoking supplementary call waiting and call holding services provided by the first network.

11. The wireless communication device of claim 9, wherein the processor is configured with processor-executable instructions to perform operations such that sending a signal to the first network activating the call forwarding function to forward additional calls to the second radio resource comprises:
transmitting a registration request message to the first network using a control channel associated with a traffic channel, wherein:
the registration request message contains an identifier associated with the second SIM and an instruction to forward incoming calls addressed to the first SIM to the second SIM using the identifier; and
the traffic channel is assigned by the first network for active calls handled by the first modem stack; and
receiving from the first network an acknowledgment of call forwarding registration.

12. The wireless communication device of claim 8, wherein the processor is configured with processor-executable instructions to perform operations further comprising:
determining whether the count of total ongoing calls being handled on the first modem stack is less than the first preset maximum count value; and
sending to the first network a request to deactivate the call forwarding function in response to determining that the count of total ongoing calls being handled on the first modem stack is less than the first preset maximum count value.

13. The wireless communication device of claim 12, wherein the processor is configured with processor-executable instructions to perform operations such that the request to deactivate the call forwarding function contains an identifier associated with the second SIM and an instruction to cease forwarding of incoming calls addressed to the first SIM.

14. The wireless communication device of claim 8, wherein the processor is configured with processor-executable instructions to perform operations further comprising:
determining whether the count of total ongoing calls being handled on the second modem stack equals the second preset maximum count value; and
sending to the first network a request to deactivate the call forwarding function in response to determining that the count of total ongoing calls being handled on the second modem stack equals the second preset maximum count value.

15. A wireless communication device, comprising:
means for monitoring a count of total ongoing calls being handled on a first modem stack corresponding to a first subscriber identification module (SIM) and a second modem stack corresponding to a second SIM, wherein the first and second SIMs are respectively associated with a first and a second radio resource;
means for determining whether the count of total ongoing calls being handled on the first modem stack is equal to a first preset maximum count value established by a first network whose provisioning information is stored on the first SIM;
means for determining whether the count of total ongoing calls being handled on the second modem stack is less than a second preset maximum count value established by a second network whose provisioning information is stored on the second SIM in response to determining that the count of total ongoing calls being handled on the first modem stack is equal to the first preset maximum count value; and
means for sending a signal to the first network activating a call forwarding function to forward additional calls to the second radio resource in response to determining that the count of total ongoing calls being handled on the second modem stack is less than the second preset maximum count value.

16. The wireless communication device of claim 15, wherein:
the count of total ongoing calls being handled on the first modem stack comprises a sum of active and held calls on the first modem stack; and
the count of total ongoing calls being handled on the second modem stack comprises a sum of active and held calls on the second modem stack.

17. The wireless communication device of claim 16, wherein the first preset maximum count value established by the first network comprises two calls, wherein the first modem stack is capable of handling two ongoing calls by invoking supplementary call waiting and call holding services provided by the first network.

18. The wireless communication device of claim 16, wherein means for sending a signal to the first network activating the call forwarding function to forward additional calls to the second radio resource comprises:
means for transmitting a registration request message to the first network using a control channel associated with a traffic channel, wherein:
the registration request message contains an identifier associated with the second SIM and an instruction to forward incoming calls addressed to the first SIM to the second SIM using the identifier; and
the traffic channel is assigned by the first network for active calls handled by the first modem stack; and
means for receiving from the first network an acknowledgment of call forwarding registration.

19. The wireless communication device of claim 15, further comprising:
means for determining whether the count of total ongoing calls being handled on the first modem stack is less than the first preset maximum count value; and
means for sending to the first network a request to deactivate the call forwarding function in response to determining that the count of total ongoing calls being handled on the first modem stack is less than the first preset maximum count value.

20. The wireless communication device of claim 19, wherein the request to deactivate the call forwarding function contains an identifier associated with the second SIM and an instruction to cease forwarding of incoming calls addressed to the first SIM.

21. The wireless communication device of claim 15, further comprising:
means for determining whether the count of total ongoing calls being handled on the second modem stack equals the second preset maximum count value; and
means for sending to the first network a request to deactivate the call forwarding function in response to determining that the count of total ongoing calls being handled on the second modem stack equals the second preset maximum count value.

22. A non-transitory processor-readable medium having stored thereon processor-executable instructions configured to cause a processor of a wireless communication device configured with a first subscriber identification module (SIM) associated with a first radio resource and a second SIM associated with a second radio resource to perform operations comprising:
monitoring a count of total ongoing calls being handled on each of a first modem stack and a second modem stack, wherein the first and second modem stacks are respectively associated with the first and second SIMs;
determining whether the count of total ongoing calls being handled on the first modem stack is equal to a first preset maximum count value established by a first network whose provisioning information is stored on the first SIM;
determining whether the count of total ongoing calls being handled on the second modem stack is less than a second preset maximum count value established by a second network whose provisioning information is stored on the second SIM in response to determining that the count of total ongoing calls being handled on the first modem stack is equal to the first preset maximum count value; and
sending a signal to the first network activating a call forwarding function to forward additional calls to the second radio resource in response to determining that the count of total ongoing calls being handled on the second modem stack is less than the second preset maximum count value.

23. The non-transitory processor-readable medium of claim 22, wherein the stored processor-executable instructions are configured to cause the wireless communication device processor to perform operations such that:
the count of total ongoing calls being handled on the first modem stack comprises a sum of active and held calls on the first modem stack; and
the count of total ongoing calls being handled on the second modem stack comprises a sum of active and held calls on the second modem stack.

24. The non-transitory processor-readable medium of claim 23, wherein the stored processor-executable instructions are configured to cause the wireless communication device processor to perform operations such that the first preset maximum count value established by the first network comprises two calls, wherein the first modem stack is capable of handling two ongoing calls by invoking supplementary call waiting and call holding services provided by the first network.

25. The non-transitory processor-readable medium of claim 23, wherein the stored processor-executable instructions are configured to cause the wireless communication device processor to perform operations such that sending a signal to the first network activating the call forwarding function to forward additional calls to the second radio resource comprises:
transmitting a registration request message to the first network using a control channel associated with a traffic channel, wherein:
the registration request message contains an identifier associated with the second SIM and an instruction to forward incoming calls addressed to the first SIM to the second SIM using the identifier; and
the traffic channel is assigned by the first network for active calls handled by the first modem stack; and
receiving from the first network an acknowledgment of call forwarding registration.

26. The non-transitory processor-readable medium of claim 22, wherein the stored processor-executable instructions are configured to cause the wireless communication device processor to perform operations further comprising:
determining whether the count of total ongoing calls being handled on the first modem stack is less than the first preset maximum count value; and
sending to the first network a request to deactivate the call forwarding function in response to determining that the count of total ongoing calls being handled on the first modem stack is less than the first preset maximum count value.

27. The non-transitory processor-readable medium of claim 26, wherein the stored processor-executable instructions are configured to cause the wireless communication device processor to perform operations such that the request to deactivate the call forwarding function contains an identifier associated with the second SIM and an instruction to cease forwarding of incoming calls addressed to the first SIM.

28. The non-transitory processor-readable medium of claim 22, wherein the stored processor-executable instructions are configured to cause the wireless communication device processor to perform operations further comprising:
determining whether the count of total ongoing calls being handled on the second modem stack equals the second preset maximum count value;
sending to the first network a request to deactivate the call forwarding function in response to determining that the count of total ongoing calls being handled on the second modem stack equals the second preset maximum count value.
